(19) United States
(12) Patent Application Publication
(10) Pub. No.: US 2013/0016285 A1
(43) Pub. Date: Jan. 17, 2013

(54) LIGHT EMITTING ELEMENT DRIVER IC IMPLEMENTING GAMMA EXPANSION

(71) Applicant: Michel Combes, San Leandro, CA (US)

(72) Inventor: Michel Combes, San Leandro, CA (US)

(73) Assignee: INTERSIL AMERICAS INC., Milpitas, CA (US)

(21) Appl. No.: 13/208,073

(22) Filed: Aug. 11, 2011

Related U.S. Application Data
(60) Provisional application No. 61/506,588, filed on Jul. 11, 2011.

(51) Int. Cl. H04N 9/69; H03M 1/12

(52) U.S. Cl. 348/572; 348/675; 348/E09.054

(57) ABSTRACT

Described herein are light emitting element driver integrated circuits (ICs), methods for use with light emitting element driver ICs, and projector systems that include a light emitting element driver IC. A light emitting element driver IC receives a color data word from the video processor IC. Starting with the color data word received from the video processor IC, the light emitting element driver IC performs a gamma expansion function to thereby produce a gamma expanded digital or analog signal. Additionally, the light emitting element driver IC outputs, in dependence on the generated gamma expanded digital or analog signal, a gamma expanded analog drive signal for driving the light emitting element.

### PRIORITY CLAIM

This application claims priority under 35 U.S.C. 119(e) to U.S. Provisional Patent Application No. 61/506,588, filed Jul. 11, 2011, entitled LIGHT EMITTING ELEMENT DRIVER IC IMPLEMENTING GAMMA EXPANSION (Attorney Docket No. ELAN-01262US0), which is incorporated herein by reference.

### BACKGROUND

FIG. 1 illustrates an exemplary miniature projector display system 100, sometimes referred to as a picoprojector. The miniature projector system 100 can be integrated with or attached to a portable device, such as, but not limited to, a mobile phone, a smart phone, a portable computer (e.g., a laptop or netbook), a personal data assistant (PDA), or a portable media player (e.g., DVD player). The miniature projector device 100 can alternatively be integrated with or attached to a non-portable device, such as a desktop computer or a media player (e.g., a portable DVD player), but not limited thereto. The miniature projector device 100 can also be used in television applications, digital picture frame applications, as well as other applications. The miniature projector device 100 can alternatively be integrated with or attached to a non-portable device, such as a desktop computer, a media player, or a gaming console, but is not limited thereto.

Referring to FIG. 1, the projector display system 100 is shown as including a video source 102, a video analog front end (AFE) 104, a video processor integrated circuit (IC) 106, a laser diode driver (LDD) IC 108 and a voltage regulator 110. The video AFE 104 can include, e.g., one or more analog-to-digital converters (ADCs), and may not be needed where the video source is a digital video source. The video processor IC 106 can include, e.g., one or more processors, application specific integrated circuits (ASICs) and/or micro-controllers. The video processor IC 106, which can perform front-end video processing, provides multiple color data words per pixel to the LDD IC 108. Each separate IC can also be referred to as a separate chip.

Video data typically contains three primary colors, red (R), green (G) and blue (B)—which in a digital system are sent as three color data words of some length, e.g., N-bits each. All three color data words are transferred from the video processor IC 106 to the LDD IC 108 for each pixel, and thus, can also be referred to as color pixel data. It is also possible that more than three color data words may be transferred from the video processor IC 104 to the LDD IC 108 for each pixel. The video processor IC 106 can perform scaling and/or pre-distortion of the video signal before the signal is provided to the LDD IC 108. The video processor IC 106 may also perform gamma expansion of the video signal before the signal is provided to the LDD IC 108.

The voltage regulator 110 (e.g., a quad-output adjustable DC-DC buck-boost regulator, or a quad-output low-dropout regulator) can convert a voltage provided by a voltage source (e.g., a battery or AC supply) into the various voltage levels (e.g., four voltage levels V1, V2, V3 and V4) for powering the various components of the projector display device 100.

The LDD IC 108 is shown as including three DACs 109 and a data interface 122, which can be, e.g., an Inter-Integrated Circuit (12C) or a Serial Peripheral Interface (SPI) interface, but is not limited thereto. The LDD IC 108 also includes registers, and the like, which are not shown. The DACs 109 of the LDD IC 108 drive the light emitting elements 112, which can include, e.g., red, green and blue laser diodes, but are not limited thereto.

In the configuration shown in FIG. 1, the outputs of the DACs 109 are connected to the cathodes of the light emitting elements 112 and the DACs 109 pull currents through the light emitting elements 112 to cause the light emitting elements to emit light. In an alternative configuration, where the outputs of the DACs 109 are connected to the anodes of the light emitting elements, and the cathodes of the light emitting elements are connected to a low voltage rail (e.g., ground), the DACs can push a current through the light emitting elements to cause them to emit light.

The light produced by the laser diodes or other light emitting elements 112 are shown as being provided to beam splitters 114, which can direct a small percentage of the light toward one or more calibration photo-detectors (PDs) 120, and direct the remainder of the light toward projector optics 116, which include lenses, mirrors, reflection plates and/or the like. The light output by the optics 116 can be provided to one or more micro mirror(s) 118. The mirror(s) 118 can be controlled by the video processor IC 106, or another portion of the system, to raster-scan reflected light onto a surface, e.g., a screen, a wall, the back of a chair, etc.

### SUMMARY

Embodiments of the present invention are directed to a light emitting element driver integrated circuit (IC), methods for use with a light emitting element driver IC, and projector systems that include a light emitting element driver IC. In such embodiments, the light emitting element driver IC receives color data words from a video processor IC, and the light emitting element driver IC generates an analog drive signal for driving a light emitting element. The light emitting can be, e.g., a laser diode, in which case the light emitting element driver IC can be a laser diode driver (LDD) IC. Alternatively, the light emitting element can be a light emitting diode (LED), but is not limited thereto.

In accordance with an embodiment, the light emitting element driver IC receives a color data word from the video processor IC. Starting with the color data word received from the video processor IC, the light emitting element driver IC performs a gamma expansion function to thereby produce a gamma expanded digital or analog signal. Additionally, the light emitting element driver IC outputs, in dependence on the generated gamma expanded digital or analog signal, a gamma expanded analog drive signal for driving the light emitting element.

In certain embodiments, the color data word received by the light emitting element driver has not been gamma expanded by the video processor IC. In such embodiments, the gamma expansion function performed within the light emitting element driver IC can be a gamma expansion function Y=X̂c, in which case the gamma expanded analog drive signal output by the light emitting element driver IC has been gamma expanded in accordance with the gamma expansion function Y=X̂c.

In accordance with other embodiments, the color data word received by the light emitting element driver has been partially gamma expanded by the video processor IC using a first partial gamma expansion function Y=X̂a. In such embodiments, the gamma expansion function performed within the light emitting element driver IC can be a second partial gamma expansion function Y=X̂b, in which case the gamma expanded analog drive signal output by the light emitting element driver IC has been gamma expanded in accordance with the gamma expansion function Y=X̂(a*b)=X̂c. In accordance with specific embodiments, b=2, and thus, the second partial gamma expansion function is a squaring function. In such embodiments, where the desired total gamma expansion function X̂c, a=c/2, and c=a*b=(c/2)*2. In a specific embodiment, c=2.2, and a=1.1.

In accordance with some embodiments, the gamma expansion performed by the light emitting element driver IC is performed using a look-up-table (LUT) within the light emitting element driver IC that accepts an N-bit input and outputs an M-bit output, where N and M are integers, and M>N. In a specific embodiment, the gamma expanded digital or analog signal is generated at the M-bit output of the LUT, and a linear digital-to-analog converter (DAC) that includes an M-bit input accepts the M-bit output of the LUT, and outputs the analog drive signal for driving the light emitting element.

In other embodiments, a multiplying digital-to-analog converter (DAC) within the light emitting element driver IC performs the gamma expansion function and outputs the analog drive signal for driving the light emitting element.

In certain embodiments, a segmented DAC within the light emitting element driver IC implements the gamma expansion function as a piecewise linear transfer function and outputs the analog drive signal for driving the light emitting element.

In further embodiments, a linear DAC (within the light emitting element driver IC) accepts the color data word received from the video processor IC, and an analog output state (within the light emitting element driver IC) receives an analog signal output by the linear DAC and performs the gamma expansion function within the light emitting element driver IC, and outputs the analog drive signal for driving the light emitting element.

This summary is not intended to summarize all of the embodiments of the present invention. Further and alternative embodiments, and the features, aspects, and advantages of the embodiments of the invention will become more apparent from the detailed description set forth below, the drawings and the claims.

### BRIEF DESCRIPTION OF THE DRAWINGS

FIG. 1 illustrates an exemplary miniature projector display system, sometimes referred to as a picoprojector.

FIG. 2 is a simulated displayed image that includes undesirable banding that occurs when the color resolution of gamma expanded color data words are reduced to limit the number of parallel lines required between a video processor IC and an LDD IC of a miniature projector display system.

FIG. 3 illustrates a miniature projector display system, according to an embodiment of the present invention.

FIGS. 4A and 4B illustrate details of a gamma expansion and D/A conversion block shown in FIG. 3, according to embodiments of the present invention where the gamma expansion and D/A conversion block is implemented using a LUT and a DAC.

FIG. 4C illustrates details of a gamma expansion and D/A conversion block shown in FIG. 3, according to an embodiment of the present invention where the gamma expansion and D/A conversion block is implemented using a multiplying DAC.

FIG. 4D illustrates details of a gamma expansion and D/A conversion block shown in FIG. 3, according to an embodiment of the present invention where the gamma expansion and D/A conversion block is implemented using a piecewise linear segmented DAC.

FIG. 4E illustrates details of a gamma expansion and D/A conversion block shown in FIG. 3, according to an embodiment of the present invention where the gamma expansion and D/A conversion block is implemented using a DAC and an analog squaring output stage.

FIG. 5 illustrate exemplary details of the analog squaring output stage of FIG. 4E.

FIG. 6 illustrates a simulated displayed image using the piecewise linear segmented DAC embodiment described with reference to FIG. 4D.

FIG. 7 illustrates a simulated displayed image using the DAC followed by the analog squaring output stage embodiment described with reference to FIG. 4E.

FIG. 8 is a high level flow diagram that is used to summarize methods according to embodiments of the present invention.

### DETAILED DESCRIPTION

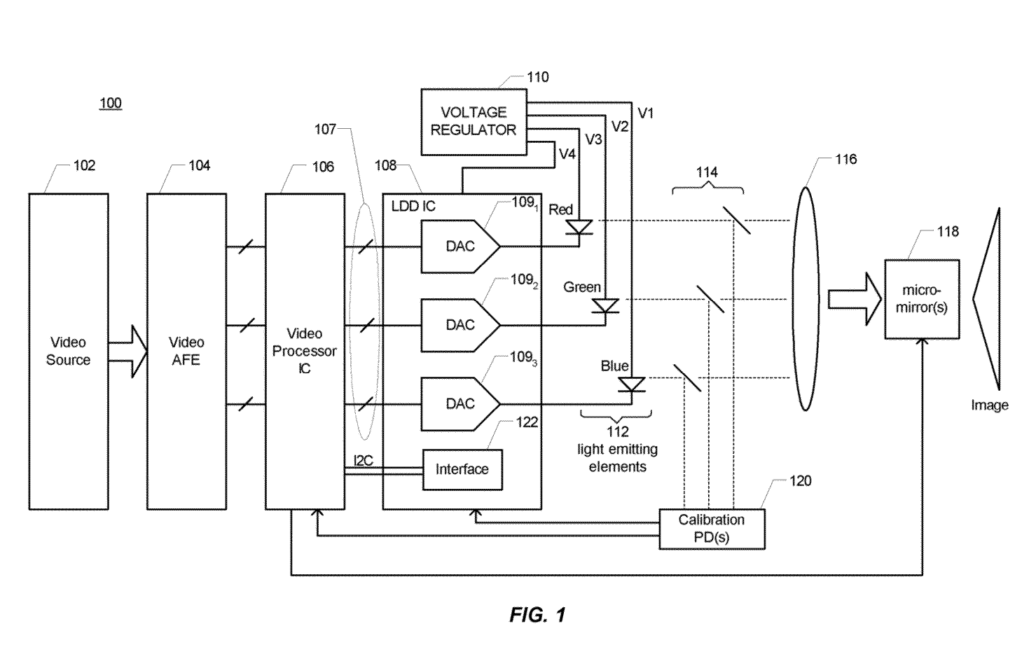

As mentioned above in the discussion of FIG. 1, the video processor IC 106 may perform gamma expansion and/or other front-end processing of the video signal (including the color data words) before the video signal is provided to the LDD IC 108. For example, as part of its front-end processing the video processor IC 106 may perform gamma expansion (also referred to as gamma decoding) of each N-bit color data word before the three (or more) color data words are transmitted from the video processor IC 106 to the LDD IC 108.

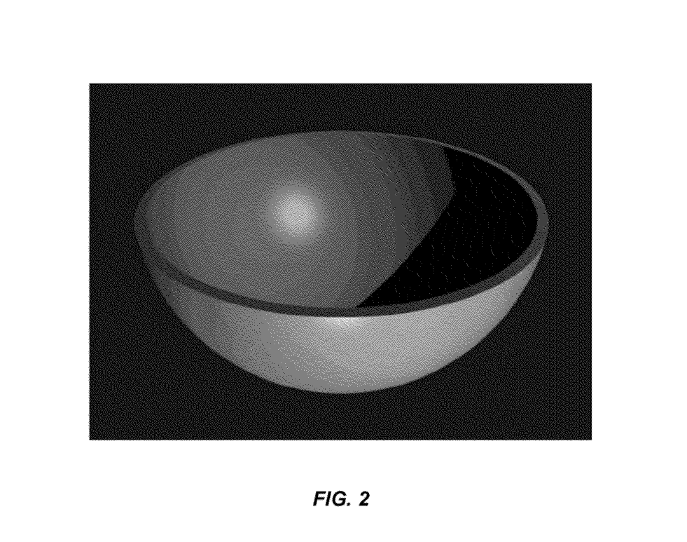

Referring back to FIG. 1, each color data word is shown as being transferred parallelly (i.e., using parallel data paths) from the video processor IC 106 to the LDD IC 108. Assuming the configuration of FIG. 1, a problem with performing the gamma expansion within the video processor IC 106 is that it increases the number of bits of each color data word, and thus, may increase the number of parallel lines between the video processor IC 106 and the LDD IC 108, and thereby may increase the number of output pins on the video processor IC 106 and input pins on the LDD IC 108, each of which is undesirable. In other words, performing the gamma expansion within the video processor IC 106 may increase the size of a video bus 107 that connects the video processor IC 106 to the driver IC 108. For example, assume each color data word includes 6-bits before gamma expansion. A typical gamma expansion function involves Y=X̂2.2, where X is a color data word before gamma expansion, and Y is the gamma expanded (also referred to as gamma decoded) color data word. Assuming that a color data word is defined by 6-bits, then it would require up to 14-bits to define the color data word after gamma expansion. Thus, if gamma expansion is performed on three 6-bit color data words within the video processor IC 106, then three 14-bit gamma expanded color data words would need to be transferred from the video processor IC 106 to the LDD IC 108 for each pixel (assuming there was no reduction in color resolution). This may require more pins and a wider video bus than desired. One way to reduce the total number of bits per color data word (after gamma expansion) would be to reduce the color resolution for each gamma expanded color data word, e.g., from 14-bits to 10-bits. However, reducing the color resolution in this manner adversely affects image quality, e.g., reduces color resolution of dark colors and/or results in undesirable banding as shown in the simulated displayed image of FIG. 2. Additionally, a further problem with performing the gamma expansion within the video processor IC 106 is that it significantly increases the data transfer bandwidth between the video processor IC 106 and the LDD IC 108 (assuming there was no reduction in color resolution), which typically increases cost and power consumption.

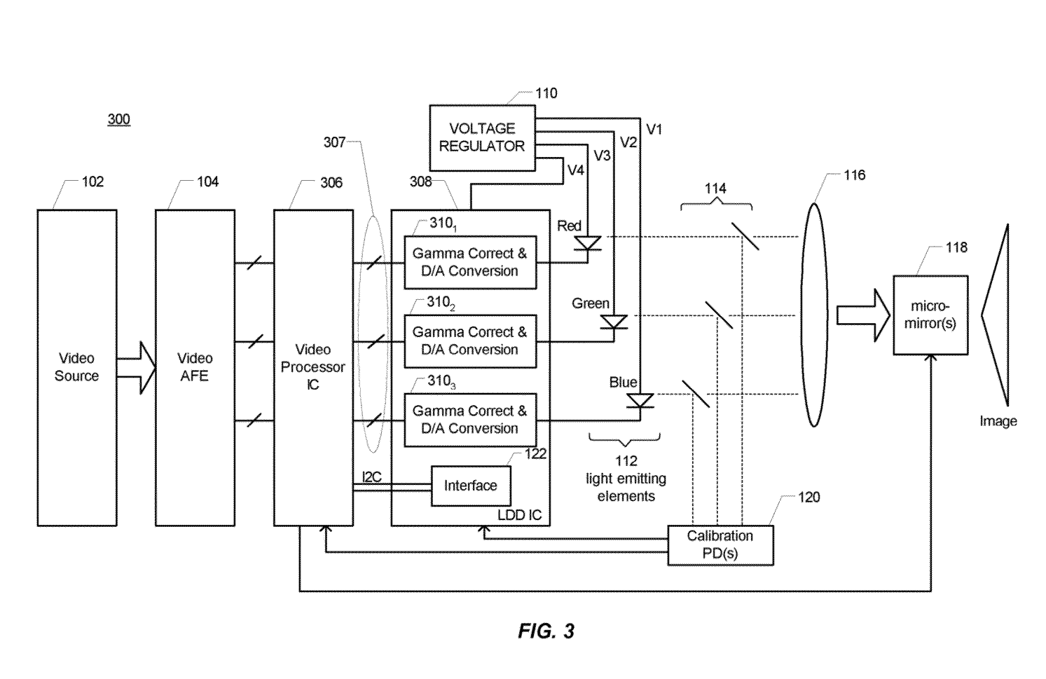

In accordance with specific embodiments of the present invention, the number of bits per color data word that is to be transferred from a video processor IC to a driver IC is reduced by performing at least some of the gamma correction (i.e., all of, or part of, the gamma expansion) within the driver IC, as will now be described with reference to FIG. 3. In certain embodiments, the video processor IC performs no gamma expansion and the driver IC performs all of the gamma expansion. In other embodiments, the video processor IC performs partial gamma expansion, and the driver IC performs further partial gamma expansion.

Referring to FIG. 3, elements that are the same or substantially similar to those elements already described with reference to FIG. 1 are labeled the same in FIG. 3. One of the distinctions between FIG. 3 and FIG. 1 is that the LDD IC 308 in FIG. 3 includes, for each light emitting element to be driven, a gamma expansion and digital-to-analog (D/A) conversion block 310, individually labeled 310₁, 310₂ and 310₃. Each block can also be referred to as a sub-system. In FIG. 3, the video bus 307 does not require as many lines as the video bus 107 in FIG. 1.

The use of alternative light emitting elements, such as light emitting diodes (LEDs), etc., is also possible. It is also possible that the LDD IC 308 drive more than three light emitting elements. More generically, the LDD driver 308 can be referred to as a light emitting element driver IC 308, or simply as a driver IC 308. However, for the remainder of this discussion the light emitting elements 112 will sometimes be referred to as laser diodes, but as just noted, can alternatively be other types of light emitting elements. Further, for the remainder of this discussion, the driver IC 308 will sometimes be referred to as an LDD driver IC, but can be a light emitting diode (LED) driver IC or any other type of light emitting element driver IC.

In some embodiments, each gamma expansion and D/A conversion block 310 includes a sub-block that performs the function Y=X̂2.2, and includes a DAC that converts Y from a digital value to an analog current (or voltage). The sub-block that performs the function Y=X̂2.2 can be a software, firmware and/or hardware that performs the actual exponential function. Alternatively, the sub-block that performs the function Y=X̂2.2 can be or a look-up-table (LUT), e.g., 6-bit input/14-bit output LUT (also known as a 64×14-bit LUT). The LUT can be stored, e.g., in ROM, but is not limited thereto. More generically, the gamma expansion function can be Y=X̂c.

The gamma expansion performed by the driver IC 308 can include all of, or at least some of, the exponential (also referred to as power-law) expansion that is typically performed within a video processor IC (e.g., the video processor IC 106). Additionally, the gamma expansion performed by the driver IC 308 can also provide at least a portion of brightness correction, white balance correction, noise filtering and/or compensation for the transfer function of the light emitting elements 112 being driven by the analog outputs of the driver IC 308, but are not limited thereto. Other portions of brightness correction, white balance correction, and/or compensation for the transfer function of the light emitting elements 112 can be performed using a calibration feedback loop that includes one or more calibration PDs 120.

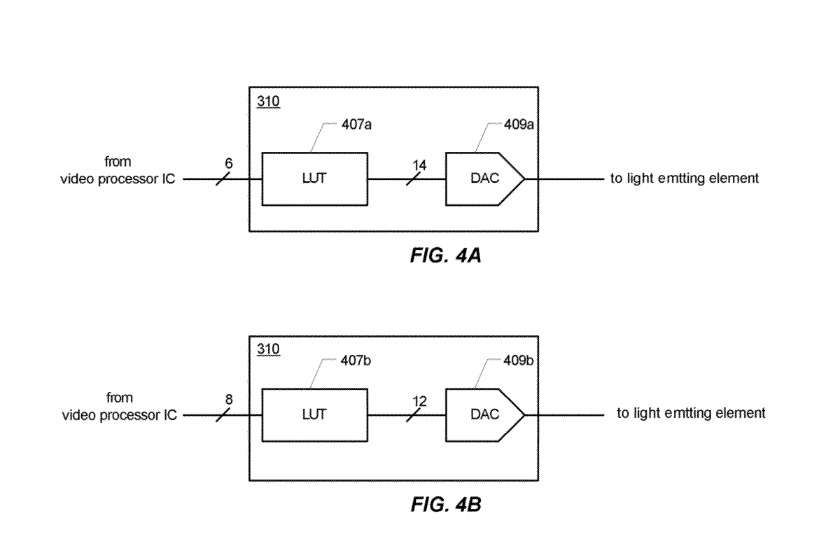

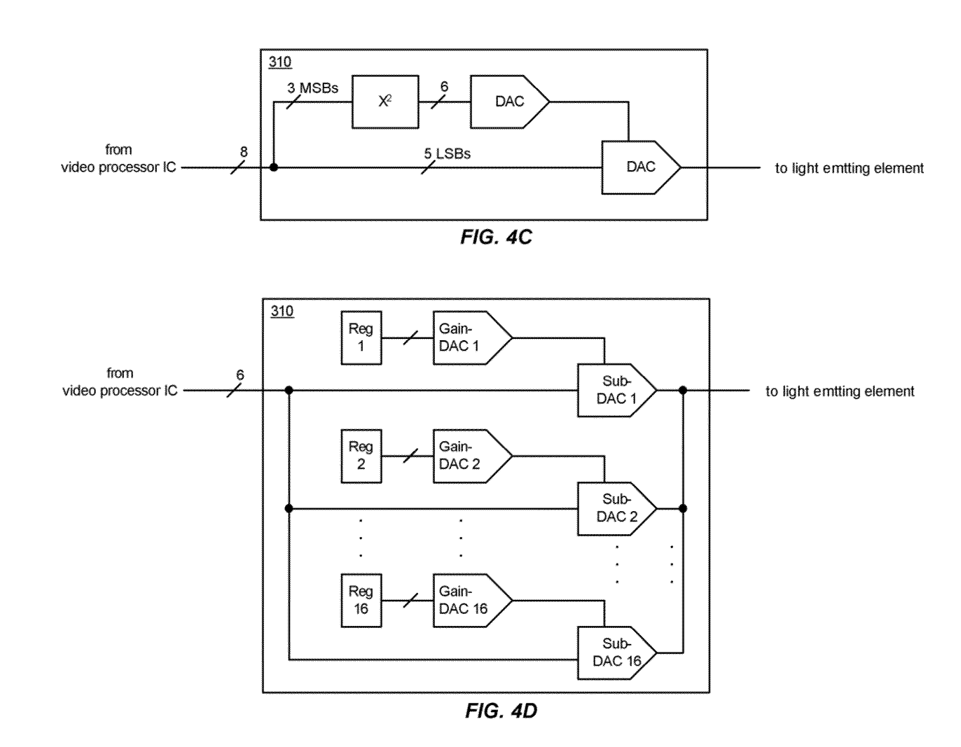

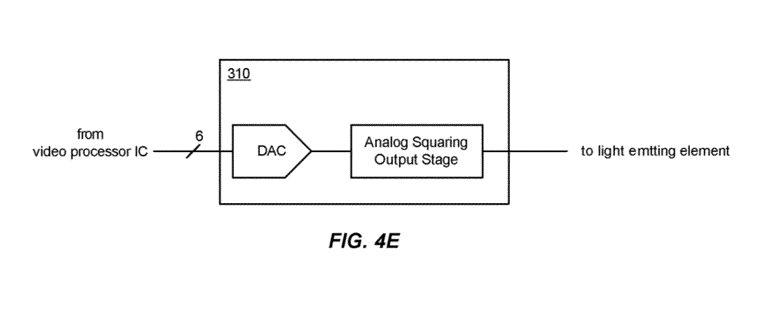

FIG. 4A illustrates an embodiment where a gamma expansion and D/A conversion block 310 is implemented using a 64×14-bit ROM LUT 407a and a 14-bit DAC 409a. While this embodiment reduces the number of bits that need to be transferred between the video processor IC 306 and the LDD IC 308, each DAC of the LDD IC 308 that is used to drive a light emitting element may be relatively large, e.g., each DAC may be a 14-bit DAC.

In other embodiments, partial gamma expansion is performed for each color data word by the video processor IC 306, and the remainder of the gamma expansion is performed by the gamma expansion and D/A conversion blocks 310 of the LDD IC 308. In a specific embodiment, the video processor IC 306 performs the function Y=X̂1.1 for each color; and each gamma expansion and D/A conversion block 310 includes a sub-block that performs the function Y=X̂2, and includes a DAC that converts Y from a digital value to an analog current (or voltage). This will result in each color data word being gamma expanded using the function Y=X̂2.2, since {X̂1.1}̂2=X̂2.2. The partial gamma expansion performed by the video processor IC 306 can be referred to as front-end partial gamma expansion (with the function more generically Y=X̂a), and the remainder of the gamma expansion performed by the LDD driver 308 can be referred to as back-end partial gamma expansion (with the function more generically Y=X̂b, where a*b=c).

If the video processor IC 306 performs Y=X̂1.1 front-end partial gamma expansion on three 6-bit color data words within the video processor IC 106, then three 7-bit partially gamma expanded color data words would need to be transferred from the video processor IC 306 to the LDD IC 108 for each pixel (assuming there was no reduction in color resolution). The sub-block that performs the back-end partial gamma expansion function Y=X̂2 can be software, firmware and/or hardware that performs the actual exponential function, or a LUT, e.g., 7-bit input/14-bit output LUT (also known as a 128×14-bit LUT). It is believed that the color resolution can be reduced from 14-bits down to 12-bits while still achieving good color reproduction without undesirable color banding. In such an embodiment, each DAC can be a 12-bit DAC. FIG. 4B illustrates an embodiment where a gamma expansion and D/A conversion block 310 is implemented using a 128×12-bit ROM LUT 407b and a 12-bit DAC 409b.

In accordance with another embodiment, the back-end partial (or only) gamma expansion can be performed using a multiplying DAC, an example of which is shown in FIG. 4C. While using a multiplying DAC allows for a smaller implementation as compared to the implementations described with reference to FIGS. 4A and 4B, the multiplying DAC embodiment would likely be slower than the implementations described with reference to FIGS. 4A and 4B. Another option for back-end partial (or total) gamma expansion is to used a segmented piecewise linear DAC, e.g., as shown in FIG. 4D. Additionally details of a segmented piecewise linear DAC are described in commonly assigned U.S. Pat. No. 7,952,507, entitled “Programmable Segmented Digital-to-Analog Converter (DAC)”, which is incorporated herein by reference.

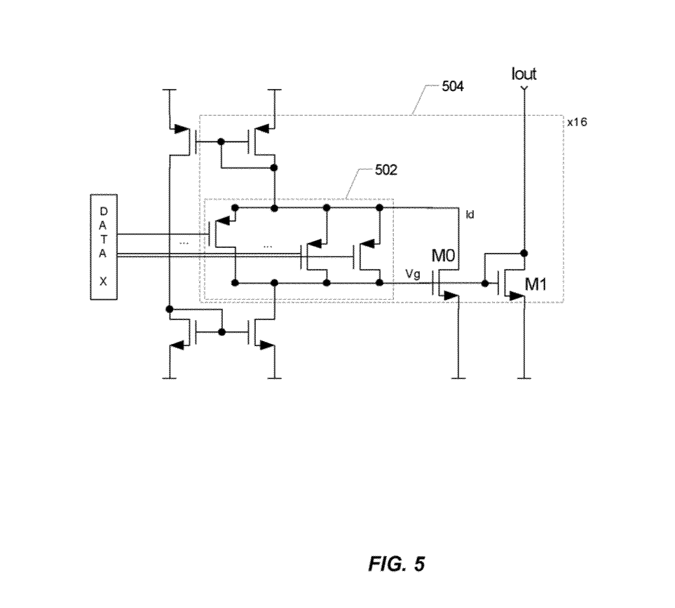

In still other embodiments, each gamma expansion and D/A conversion block 310 includes a DAC followed by an analog squaring output stage, as shown in FIG. 4E. An implementation of the analog squaring output stage, according to an embodiment of the present invention, is illustrated in FIG. 5. The squaring output stage of FIG. 5 also performs at least part of the digital to analog conversion.

Referring to FIG. 5, the circuitry 502, which is shown as including a plurality of MOS transistors having their source-drain current paths connected in parallel, converts a digital data signal value into an analog current and an analog voltage that are each proportional to the value of the digital data signal. The analog current generated by circuitry 502 forces a drain current (proportion to the digital data signal value) into the drain of transistor M0, and the analog voltage (proportion to the digital data signal value) biases the gate of the transistor M0, resulting in the drain current of transistor M0 being proportional to the square of the value of the digital data signal. The transistor M1 replicates the drain current (and optionally provides gain) to produce Iout, which is the current used to drive a light emitting element. The circuitry 504 can be replicated a number of times, e.g., ×16, to produce a current Iout that is of sufficient amperage (i.e., to scale up the current) to drive the light emitting element. The transistors of circuitry 502 can be binary weighted. Alternatively, the transistors of circuitry 502 can be equally weighted, in which case the digital signal should be converted (e.g., decoded) to a thermometer code before driving the gates of the transistors of circuitry 502.

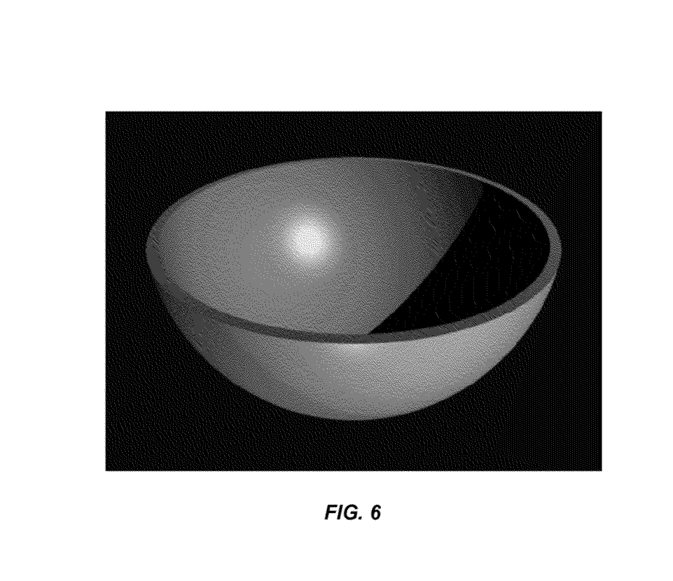

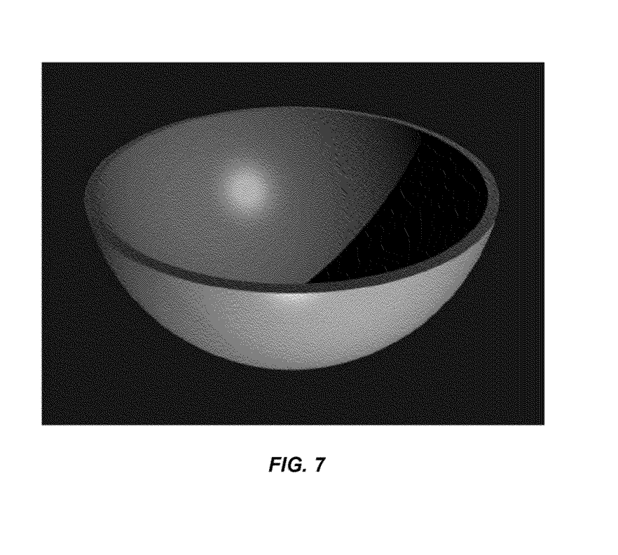

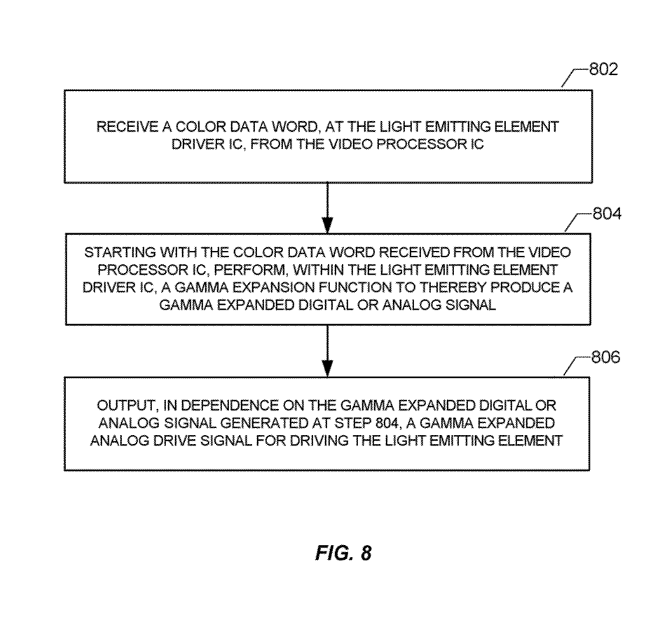

FIG. 6 illustrates a simulated displayed image using the piecewise linear segmented DAC embodiment described with reference to FIG. 4D. FIG. 7 illustrates a simulated displayed image using the DAC followed by the analog squaring output stage embodiment described with reference to FIG. 4E. There is significantly less color banding in FIGS. 4D and 4E, as compared to in FIG. 2.

In some of the embodiments described above, all of the gamma expansion to the color data words (e.g., R, G and B color data words) is performed within the light emitting element driver IC after the driver IC receives non-gamma expanded color data words from the video processor IC. In still other embodiments, back-end partial gamma expansion to color data words is performed within the light emitting element driver IC after the driver IC receives partially gamma expanded color data words from the video processor IC. In specific embodiments described above, the front-end partial gamma expansion performed by the video processor IC was described as using the function Y=X̂1.1, while the back-end partial gamma expansion performed by the light emitting element driver IC was described as using the function Y=X̂2. Such embodiments can be readily implemented because it is relatively easy to implement digital and analog squaring functions. Nevertheless, it is also within the scope of the present invention that the gamma expansion be divided between front-end and back-end partial expansions in other manners. For example, the video processor IC can perform front-end gamma expansion using the function Y=X̂1.375, while the back-end partial gamma expansion performed by the light emitting element driver IC uses the function Y=X̂1.6. It is also possible that the total desired gamma expansion is a function other than X̂2.2. In other words, while a commonly used decoding gamma is 2.2, use of other decoding gammas is also within the scope of the present invention. More specifically, in accordance with specific embodiments, the decoding gamma (γ) is any value greater than 1 and less than or equal to 3, i.e., 1≦γ≦3.

Referring back to FIG. 3, the gamma expansion and D/A conversion blocks 310 were described as performing partial (or total) gamma expansion of color data words received from the video processor IC 306. However, it is also within the scope of the present invention that the transfer functions of the blocks 310 include additional processing functions, such as, predistortion and/or interpolation, but not limited thereto. Accordingly, each block 310 can more generically be referred to as a DAC configured to perform a digital color data to analog output current non-linear transfer function. The non-linear transfer function can include partial (or total) gamma expansion, predistortion and/or interpolation, but is not limited thereto. Referring briefly to FIGS. 4A and 4B, the DACs 409a and 409b may be purely linear DACs, but together with their respective LUTs 407a and 407b, the block 310 can be considered a DAC configured to perform a digital color data to analog output current non-linear transfer function.

One or more of the light emitting elements 112 can have a substantially linear current to output power transfer function above the lasing threshold, e.g., where a light emitting element is a solid state laser diode, such as, but not limited to, a Diode-pumped solid-state (DPSS) laser diode. It is also possible that one or more light emitting elements can have a substantially non-linear current to output power transfer function, e.g., where a light emitting element is a second harmonic generation (SHG) laser diode, which is sometimes used as the green (G) light emitting element 112. In accordance with embodiments of the present invention, the transfer function of the light emitting element being driven by the output of a block 310 should be considered when specifying (e.g., designing and implementing) the transfer function for the block 310 so that the overall transfer function implemented by a color channel (which includes the video processor IC 306, the block 310 of the light emitting element driver IC 308, and the light emitting element 112) is the desired transfer function (e.g., including gamma expansion, interpolation and/or predistortion, but not limited thereto). For example, where a light emitting element has a non-linear transfer function, the non-linear transfer function of the light emitting element can be used to achieve part of the gamma expansion desired for the channel.

In FIGS. 3 and 4A-4E, the gamma correction and D/A conversion blocks 310 of the driver IC 308 are shown as parallelly receiving color data words from the video processor IC 306 over a parallel data bus. In alternative embodiments, where the video processor is configured to transfer each of the color data words serially over a serial data bus, the gamma correction and D/A conversion blocks 310 of the driver IC 308 can serially receive color data words from the video processor IC. In such alternative embodiments, performing all or part of the gamma expansion within the driver IC 308 may not achieve the pin count efficiencies for the driver IC 308 mentioned above, but will still advantageously help to mitigate the data transfer bandwidth between the video processor IC 306 to the driver IC 308. Further, if the video processor IC 306 is configured to transfer each of the color data words serially over a serial data bus after full gamma expansion is performed within the video processor IC 306, this may necessitate relatively fast clock speeds within the video processor IC and the driver IC (to handle the high data transfer bandwidth). Advantageously, performing all or part of the gamma expansion within the driver IC 308 can allow for reductions in such clock speeds. Regardless of whether the color data words are transferred serially or in parallel between the video processor IC 306 to the driver IC 308, it would be beneficial to use a high speed data transfer technique, such as, but not limited to, low-voltage differential signaling (LVDS) and/or double data rate (DDR).

FIG. 8 is a high level flow diagram that is used to summarize methods according to embodiments of the present invention. The method of FIG. 8 is for use by a light emitting element driver IC that receives color data words from a video processor IC. The method of FIG. 8 is for generating an analog drive signal for driving a light emitting element. Referring briefly back to FIG. 3, the method of FIG. 8 can be performed by each of the blocks 310 independently and in parallel. In other words, the method of FIG. 8 can be performed for each of a plurality of different color data words, e.g., an R color data word, a G color data word and a B color data word, but is not limited thereto.

Referring to FIG. 8, at step 802, a color data word is received at the light emitting element driver IC (e.g., 308), from the video processor IC (e.g., 306). At step 804, starting with the color data word received from the video processor IC, a gamma expansion function is performed within the light emitting element driver IC to thereby produce a gamma expanded digital or analog signal. At step 806, the light emitting element driver IC outputs, in dependence on the gamma expanded digital or analog signal generated at step 804, a gamma expanded analog drive signal for driving the light emitting element (e.g., one of the light emitting elements 112).

In accordance with some embodiments, the color data word received at step 802 has not been gamma expanded by the video processor IC. In such embodiments, the gamma expansion function performed at step 804, within the light emitting element driver IC, can be generically referred to as a gamma expansion function Y=X̂c. This results in the gamma expanded analog drive signal, output at step 806, having been gamma expanded in accordance with the gamma expansion function Y=X̂c.

In accordance with other embodiments, the color data word received at step 802 has been partially expanded by the video processor IC using a first partial gamma expansion function Y=X̂a. In such embodiment, the gamma expansion function performed at step 804, within the light emitting element driver IC, is a second partial gamma expansion function Y=X̂b. This results in the gamma expanded analog drive signal, output at step 806, having been gamma expanded in accordance with the gamma expansion function Y=X̂(a*b)=X̂c. In specific embodiments, b=2, and thus, the second partial gamma expansion function is a squaring function, which is relatively easy and efficient to implement. In such embodiments, where the desired gamma expansion is X̂c, a=c/2. For a specific example, a=1.1, b=2 and c=2.2.

To illustrate the above described embodiments, assume that the color data word received at step 802 is an N-bit color data word. Also assume that the N-bit color data word received at step 802 would include at least M-bits if the N-bit color data word was already fully gamma expanded by the video processor IC to have the gamma expansion function Y=X̂c, wherein M>N. Using the embodiments described herein, rather than requiring the M-bits be transferred from the video processor IC to the driver IC per color data word, N-bits can instead be transferred from the video processor IC to the driver IC per color data word, where N<M. Using such embodiments, the fully gamma expanded analog drive signal output at step 806 can be substantially equal to an analog drive signal that would be generated if an M-bit fully gamma expanded color data word was received by the driver IC and was converted to an analog drive signal using a linear digital-to-analog converter (DAC) of the driver IC.

In accordance with certain embodiments described above with reference to FIGS. 4A and 4B, step 804 is performed using an LUT within the light emitting element driver IC that accepts an N-bit input and outputs an M-bit output, where N and M are integers, and M>N. The gamma expanded digital or analog signal generated at step 804 is generated at the M-bit output of the LUT. In such embodiments, step 806 is performed using a linear DAC that includes an M-bit input that accepts the M-bit output of the LUT.

In other embodiments described above with reference to FIG. 4C, step 804 and 806 are performed using a multiplying DAC within the light emitting element driver IC.

In still other embodiments, described above with reference to FIG. 4D, steps 804 and 806 are performed using a segmented DAC within the light emitting element driver IC that implements the gamma expansion function as a piecewise linear transfer function.

In still further embodiments, step 804 is preformed using a linear DAC and an analog output stage within the light emitting element driver IC. The linear DAC accepts the color data word received from the video processor IC, and outputs an analog signal that is indicative of (e.g., directly proportional to) the color data word received from the video processor IC. The analog output stage receives the analog signal output by the linear DAC and performs the gamma expansion function within the light emitting element driver IC. Here, the gamma expanded analog drive signal, output at step 806, is the output of the analog output stage. In specific embodiments, the analog output stage comprises an analog squaring output stage, which is relatively easy and efficient to implement. An exemplary analog squaring output stage was described with reference to FIG. 5.

As mentioned above, the gamma expansion function performed by the light emitting element driver IC at step 804 can include all of, or at least some of, the exponential (also referred to as power-law) expansion that is typically performed within a video processor IC, as well as brightness correction, white balance correction, and/or compensation for the transfer function of the light emitting elements being driven by the analog outputs of the driver IC, but are not limited thereto.

Embodiments of the present invention have been described above with the aid of functional building blocks illustrating the performance of specified functions and relationships thereof. The boundaries of these functional building blocks have sometimes been defined herein for the convenience of the description. Unless otherwise specified, alternate boundaries can be defined so long as the specified functions and relationships thereof are appropriately performed. Any such alternate boundaries are thus within the scope and spirit of the claimed invention. While portions of the invention can be implemented using hardware, other portions of the invention can be implemented using software and/or firmware. Such software and/or firmware can be implemented as a non-transitory computer readable medium, including instructions stored thereon which when read and executed by one or more processors, cause the one or more processors, but not limited thereto, to perform and/or control specific steps described above. Such processor(s) can also be used to implement certain blocks discussed above, or portions thereof.

The forgoing description is of the preferred embodiments of the present invention. These embodiments have been provided for the purposes of illustration and description, but are not intended to be exhaustive or to limit the invention to the precise forms disclosed. Many modifications and variations will be apparent to a practitioner skilled in the art. Embodiments were chosen and described in order to best describe the principles of the invention and its practical application, thereby enabling others skilled in the art to understand the invention. Slight modifications and variations are believed to be within the spirit and scope of the present invention. It is intended that the scope of the invention be defined by the following claims and their equivalents.

What is claimed:

1. A method for use by a light emitting element driver integrated circuit (IC) that receives color data words from a video processor IC, the method for generating an analog drive signal for driving a light emitting element, the method comprising:
(i) receiving a color data word, at the light emitting element driver IC, from the video processor IC;
(ii) starting with the color data word received from the video processor IC, performing, within the light emitting element driver IC, a gamma expansion function to thereby produce a gamma expanded digital or analog signal; and
(iii) outputting from the light emitting element driver IC, in dependence on the gamma expanded digital or analog signal generated at step (ii), a gamma expanded analog drive signal for driving the light emitting element.

2. The method of claim 1, wherein:
the color data word received at step (i) has not been gamma expanded by the video processor IC;
the gamma expansion function performed at step (ii), within the light emitting element driver IC, is a gamma expansion function Y=X̂c; and
the gamma expanded analog drive signal, output at step (iii), has been gamma expanded in accordance with the gamma expansion function Y=X̂c.

3. The method of claim 1, wherein:
the color data word received at step (i) has been partially expanded by the video processor IC using a first partial gamma expansion function Y=X̂a;
the gamma expansion function performed at step (ii), within the light emitting element driver IC, is a second partial gamma expansion function Y=X̂b; and
the gamma expanded analog drive signal, output at step (iii), has been gamma expanded in accordance with the gamma expansion function Y=X̂(a*b)=X̂c.

4. The method of claim 3, wherein:
b=2, and thus, the second partial gamma expansion function is a squaring function;
a=c/2; and
c=a*b=(c/2)*2.

5. The method of claim 4, wherein:
c=2.2; and
a=1.1.

6. The method of claim 1, wherein:
step (ii) is performed using a look-up-table (LUT) within the light emitting element driver IC that accepts an N-bit input and outputs an M-bit output, where N and M are integers, and M>N;
the gamma expanded digital or analog signal generated at step (ii) is generated at the M-bit output of the LUT; and
step (iii) is performed using a linear digital-to-analog converter (DAC) that includes an M-bit input that accepts the M-bit output of the LUT.

7. The method of claim 1, wherein steps (ii) and (iii) are performed using a multiplying digital-to-analog converter (DAC) within the light emitting element driver IC.

8. The method of claim 1, wherein steps (ii) and (iii) are performed using a segmented digital-to-analog converter (DAC) within the light emitting element driver IC that implements the gamma expansion function as a piecewise linear transfer function.

9. The method of claim 1, wherein:
step (ii) is performed using a linear digital-to-analog converter (DAC) and an analog output stage within the light emitting element driver IC;
the linear DAC accepts the color data word received from the video processor IC, and outputs an analog signal that is indicative of the color data word received from the video processor IC;
the analog output stage receives the analog signal output by the linear DAC and performs the gamma expansion function within the light emitting element driver IC; and
the gamma expanded analog drive signal, output at step (iii), is the output of the analog output stage.

10. The method of claim 9, wherein the analog output stage comprises an analog squaring output stage.

11. The method of claim 1, wherein:
light emitting element driver IC is a laser diode driver (LDD) IC for use in a projector; and
the light emitting element is a laser diode.

12. The method of claim 1, the gamma expansion function performed at step (ii), within the light emitting element driver IC, includes at least a portion of one or more of the following:
exponential expansion;
brightness correction;
white balance correction;
noise filtering; and
compensation for a transfer function of a light emitting element.

13. A light emitting element driver integrated circuit (IC) that receives color data words from a video processor IC, and generates an analog drive signal for driving a light emitting element, the light emitting element driver IC comprising:
a gamma expander and digital to analog conversion sub-system configured to
(i) receive a color data word from the video processor IC;
(ii) perform a gamma expansion function, starting with the received the color data word received from the video processor IC, to thereby produce a gamma expanded digital or analog signal; and
(iii) output a gamma expanded analog drive signal, in dependence on the generated gamma expanded digital or analog signal, wherein the gamma expanded analog drive signal is for driving the light emitting element.

14. The light emitting element driver IC of claim 13, wherein:
the color data word received from the video processor IC has been not been gamma expanded by the video processor IC;
the gamma expansion function performed by the gamma expander and digital to analog conversion sub-system is a gamma expansion function Y=X̂c; and
the gamma expanded analog drive signal, output by the gamma expander and digital to analog conversion sub-system, has been gamma expanded in accordance with the gamma expansion function Y=X̂c.

15. The light emitting element driver IC of claim 13, wherein:
the color data word received from the video processor IC has been not been partially gamma expanded by the video processor IC using a first partial gamma expansion function Y=X̂a;
the gamma expansion function performed by the gamma expander and digital to analog conversion sub-system is a second partial gamma expansion function Y=X̂b; and
the gamma expanded analog drive signal, output by the gamma expander and digital to analog conversion sub-system, has been gamma expanded in accordance with the gamma expansion function Y=X̂(a*b)=X̂c.

16. The light emitting element driver IC of claim 15, wherein:
b=2, and thus, the second partial gamma expansion function is a squaring function;
a=c/2; and
c=a*b=(c/2)*2.

17. The light emitting element driver IC of claim 16, wherein:
c=2.2; and
a=1.1.

18. The light emitting element driver IC of claim 13, wherein the gamma expander and digital to analog conversion sub-system comprises:
a look-up-table (LUT) that accepts an N-bit input color data word from the video processor IC and outputs an M-bit gamma expanded digital signal, where N and M are integers, and M>N; and
a linear DAC that includes an M-bit input that accepts the M-bit output of the LUT, and outputs the gamma expanded analog drive signal for driving the light emitting element.

19. The light emitting element driver IC of claim 13, wherein the gamma expander and digital to analog conversion sub-system comprises a multiplying digital-to-analog converter (DAC).

20. The light emitting element driver IC of claim 13, wherein the gamma expander and digital to analog conversion sub-system comprises a segmented DAC that implements the gamma expansion function as a piecewise linear transfer function.

21. The light emitting element driver IC of claim 13, wherein the gamma expander and digital to analog conversion sub-system comprises:
a linear DAC that accepts the color data word received from the video processor IC, and outputs an analog signal that is indicative of the color data word received from the video processor IC; and
an analog output stage that receives the analog signal output by the linear DAC, performs the gamma expansion function, and outputs the gamma expanded analog drive signal for driving the light emitting element.

22. The light emitting element driver IC of claim 21, wherein the analog output stage comprises an analog squaring output stage.

23. The light emitting element driver IC of claim 13, wherein light emitting element driver IC is a laser diode driver (LDD) IC for use in a projector.

24. A projector system, comprising:
a video processor integrated circuit (IC) configured to output color data words;
a light emitting element driver IC configured to receive the color data words from the video processor IC;
a video bus, connected between the video processor IC and the light emitting element driver IC, that transfers the color data words from the video processor IC to the light emitting driver IC;
wherein the color data words transferred via the video bus from the video processor IC to the light emitting driver IC have either not been gamma expanded by the video processor IC, or have been partially gamma expanded by the video processor IC; and
wherein the light emitting element driver IC includes a gamma expander and digital to analog conversion sub-system configured to
(i) receive a color data word from the video processor IC;
(ii) perform a gamma expansion function, starting with the color data word received from the video processor IC, to thereby produce a gamma expanded digital or analog signal; and
(iii) output a gamma expanded analog drive signal, in dependence on the generated gamma expanded digital or analog signal, wherein the gamma expanded analog drive signal is for driving the light emitting element.
